(19) United States
(12) Patent Application Publication
(10) Pub. No.: US 2007/0165217 A1
(43) Pub. Date: Jul. 19, 2007

(54) Sensor structure and methods of manufacture and uses thereof

(76) Inventors: Anders Johansson, Uppsala (SE); Jan-Otto Carlsson, Uppsala (SE); Mats Boman, Jarlasa (SE); Pierre Strombeck, Lidingo (SE); Peter Strombeck, Lidingo (SE)

Correspondence Address: KENYON & KENYON LLP, ONE BROADWAY, NEW YORK, NY, 10004, US

(21) Appl. No.: 11/482,567

(22) Filed: Jul. 7, 2006

Related U.S. Application Data
(60) Provisional application No. 60/697,358, filed on Jul. 8, 2005.
(60) Provisional application No. 60/697,359, filed on Jul. 8, 2005.

(51) Int. Cl. G01J 3/44; G01N 21/65

(52) U.S. Cl. 356/301

(57) ABSTRACT

A sensor structure, and a method if using and manufacturing the sensor structure. The manufacture of the sensor structure may include the steps of providing a deposition solution in the pores of an anodic alumina membrane, distributing the deposition solution in the pores of the membrane, heating the membrane to evaporate the solvent and deposit the nano particles, cleaning the membrane and repeating the procedure until a predetermined size and distribution of the deposited nano particles is achieved.

### RELATED APPLICATIONS

This application is based on and claims the benefit of priority to Applicants' co-pending U.S. Provisional Patent Appl. Ser. Nos. 60/697,358 and 60/697,359, both filed Jul. 8, 2005, the disclosures of which are hereby incorporated in their entirety by reference.

### TECHNICAL FIELD

The present invention relates generally to nano-structured materials, and more particularly to the manufacture and uses of materials comprising a permeable anodic alumina membrane with deposited nano-particles in the pores.

### BACKGROUND

Nanotechnology is an ever expanding field of research, for example, in areas of science including, but not limited to, mechanics, medicine, electronics and materials.

Specifically, the development of nano-structured surfaces has become of large interest for areas such as catalysis and analysis. At present there is a demand for small, cheap and highly sensitive sensor materials for simultaneous detection of a plurality of substances. Specifically, there is a need for sensors that can readily be utilized in publicly available places, such as railway stations, airports, subway stations, etc. A very specific application area is the detection of explosives, where there are a multitude of various substances that may need to be detected.

Several types of sensors for detecting explosive compounds are known. An efficient method is the use of canines for mobile and versatile detection of various substances. Other sensors include various chemically-based detectors, micro electromechanical sensors (MEMS), semi conducting organic polymers, etc.

The majority of the presently known detectors and methods of detection are expensive. In order to provide an efficient detection, e.g. by utilizing many detectors, of possible occurrences of those potentially dangerous substances in public areas, the sensors need to be small, sensitive and fairly cheap.

One material which has been of interest is so-called anodic alumina membranes, and also of interest have been different methods of attaining a nano-structured material by utilizing such membranes.

Known methods of obtaining nano-structures in the pores of anodic alumina membranes include:
synthesizing gold nanoparticles in a solution and attaching the particles on the pore walls of porous anodic alumina using various chemical routes.
using Au₅₅ clusters with a variety of stabilising ligands which are then attached to the pore walls and thermally treated to obtain nanoparticles on the pore walls.

One exemplary area of science that benefits from the use of nano-structured materials is Raman spectroscopy, especially for selective detection of several molecules at the same time. Raman spectroscopy enables detection of fingerprint type of spectra, i.e., complicated spectra with several peaks, which are identified to certain molecules. Finger print types of spectra are normally located in the region 600-1200 cm⁻¹. Raman spectroscopy also distinguishes and detects different functional groups in a molecule, such as —N02, —COOH, —C—N, etc. Functional groups are found in the region 1200 to 3500 cm⁻¹. Until now a Raman spectrometer has been a complicated and very sensitive instrument. The reason for this is the need for a very high dispersion since most peaks in a Raman spectra are very close to the excitation wavelength 50-3000 cm⁻¹.

A problem using a Raman spectrometer for detection of e.g. ultra low concentrations in the gas phase is the low sensitivity of the technique. In normal Raman spectroscopy only 1 out of 10⁷ photons are Raman scattered. Fortunately, the Raman signal can be amplified by the use of certain surfaces where surface enhanced Raman scattering occurs. The Raman scattering from a compound (or ion) adsorbed on or even within a few Angstroms of a structured metal surface can be 10³-10⁶ times greater than in solution. This surface-enhanced Raman scattering is strongest on silver, but is observable on gold, copper, and palladium as well. At practical excitation wavelengths, enhancement on other metals is unimportant. Surface-enhanced Raman scattering (SERS) arises from two mechanisms.

The first is an enhanced electromagnetic field produced at the surface of the metal. When the wavelength of the incident light is close to the plasma wavelength of the metal, conduction electrons in the metal surface are excited into an extended surface electronic excited state called a surface plasmon resonance. Molecules adsorbed or in close proximity to the surface experience an exceptionally large electromagnetic field. Vibrational modes normal to the surface are most strongly enhanced.

The second mode of enhancement is by the formation of a charge-transfer complex between the surface and analyte molecule i.e. molecule to be analyzed or detected. The electronic transitions of many charge transfer complexes are in the visible, so that resonance enhancement occurs.

Molecules with lone-pair electrons or π-clouds show the strongest SERS. The effect was first discovered with pyridine. Other aromatic nitrogen or oxygen containing compounds, such as aromatic amines or phenols, are strongly SERS active. The effect can also be seen with other electron-rich functionalities such as carboxylic acids.

The intensity of the surface plasmon resonance is dependent on many factors including the wavelength of the incident light and the morphology of the metal surface. The wavelength should match the plasma wavelength of the metal. This is about 382 nm for a 5 nm silver particle, but can be as high as 600 nm for larger ellipsoidal silver particles. The plasma wavelength is to the red of 650 nm for copper and gold, the other two metals which show SERS at wavelengths in the 350-1000 nm region. The best morphology for surface plasmon resonance excitation is a small (<100 nm) particle or an atomically rough surface.

SERS is typically used to study mono-layers of materials adsorbed on metals, including electrodes. Many formats other than electrodes can be used. The most popular include colloids, metal films on dielectric substrates and, recently, arrays of metal particles bound to metal or dielectric colloids through short linkages. In addition SERS is also a well established analysis instrument for detecting low concentrations of a large variety of compounds in gases and liquids. However, until now the SERS instruments have been complicated, large, sensitive to disturbance and expensive, thereby limiting the application of the technique to laboratories and factories.

Many studies have been performed for the purpose of creating e.g. a good SERS surface. Most of the studies have been based on lithographically patterned gold or silver surfaces, which give good control of the surface topography, but lack the highly enlarged surface, which is required for analysing very low concentrations.

Therefore, there is a need for improved nano-structures with large surfaces, controllable particle size and distribution to provide highly sensitive sensors.

### SUMMARY

An embodiment of the present invention relates to a nano-structured permeable material.

Another embodiment provides a method of manufacturing a sensor structure comprising a permeable anodic alumina membrane with deposited nano particles on the pore walls.

Yet another embodiment provides a sensor structure comprising a permeable anodic alumina membrane with deposited multilayered nano particles on the pore walls.

A further embodiment provides a method of manufacturing a permeable anodic alumina membrane with deposited multilayered nano particles on the pore walls.

An embodiment of the present invention provides an improved sensor for simultaneous detection of a plurality of compounds.

A further embodiment of the present invention provides a use for a sensor structure that comprises an anodic alumina membrane with deposited silver or gold nanoparticles in the pores.

Another embodiment of the present invention provides a use for a sensor structure that comprises an anodic alumina membrane with deposited nanoparticles in the pores, where the nanoparticles are homogeneous or non-homogeneous silver- and/or gold-containing particles.

An embodiment of the present invention enables using an anodic alumina membrane with deposited silver or gold nanoparticles in the pores as a sensor material for surface enhanced Raman spectroscopy.

Yet another embodiment enables using anodic alumina membrane with deposited silver or gold nanoparticles in the pores for detecting explosive compounds in the atmosphere.

The present invention, according to various embodiments thereof, comprises a method of manufacturing a sensor structure. In an embodiment, the sensor structure may be suitable for, but is not limited to, use in surface enhanced Raman spectroscopy. The method may comprise the steps of providing a deposition solution in the pores of an anodic alumina membrane, heating the membrane to evaporate the solvent and deposit a solid, repeating the procedure until a predetermined size and distribution of the deposited nano particles is achieved.

The present invention, according to various embodiments thereof, comprises using a permeable anodic alumina membrane with deposited silver or gold nanoparticles on the pore walls as a detection surface/volume for surface enhanced Raman spectroscopy to detect molecules indicative of explosive compounds.

Also, the invention comprises a sensor structure comprising an anodic alumina membrane with multilayered deposited nanoparticles on the pore walls, and a method of manufacturing the multilayered particles.

An advantages of the present invention may include the provision of a sensor structure with a large analysis surface area. A further advantages of the present invention may include the provision of a sensor structure with increased sensitivity to ultra low concentrations of molecules in gases or liquids. A still further advantages of the present invention may include the provision of a sensor structure with nanoparticles with controlled size and distribution. A still further advantage of the present invention, according to various embodiments thereof, is the provision of improved detection of ultra-low concentrations of explosive compounds, and highly sensitive, versatile and cost efficient detection.

### BRIEF DESCRIPTION OF THE DRAWINGS

The invention, together with further objects and advantages thereof, may best be understood by making reference to the following description taken together with the accompanying drawings, in which:

FIGS. 1a-b are micrographs of a porous anodic alumina membrane suitable for the invention;

FIG. 2 is a schematic flow diagram of an embodiment of a method of manufacture according to the invention.

FIGS. 3a-b are micrographs of a sensor structure according to an embodiment of the invention;

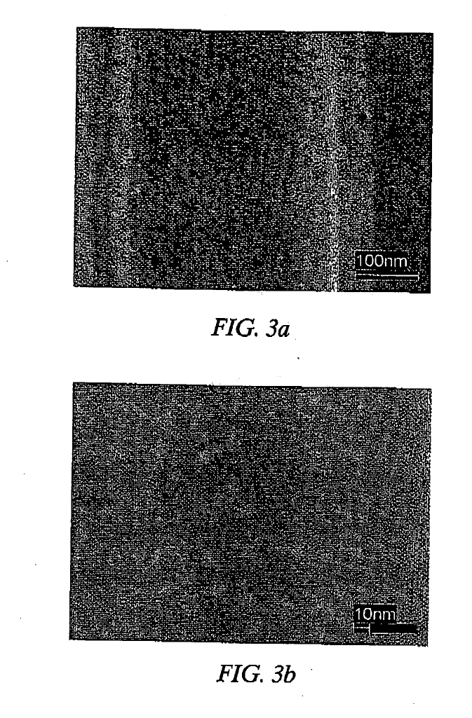

FIG. 4 is a schematic illustration of a sensor structure according to an embodiment of the invention;

FIGS. 5a-c are schematic illustrations of deposited particles according to various embodiments of the invention; and

FIG. 6 illustrates an arrangement for using the sensor structure, according to various embodiments of the invention.

### DETAILED DESCRIPTION

The present invention is described herein in the context of surface enhanced Raman spectroscopy (SERS) and detection of minute amounts of substances using SERS. However, it should be recognized that the structures and methods described below can additionally or alternatively be utilized for catalysis, photonic waveguides, magnetic structures etc.

The present invention may provide a cheap sensor surface with nano-sized structures to optimize, e.g., the Raman, scattering in order to provide a maximum amplification.

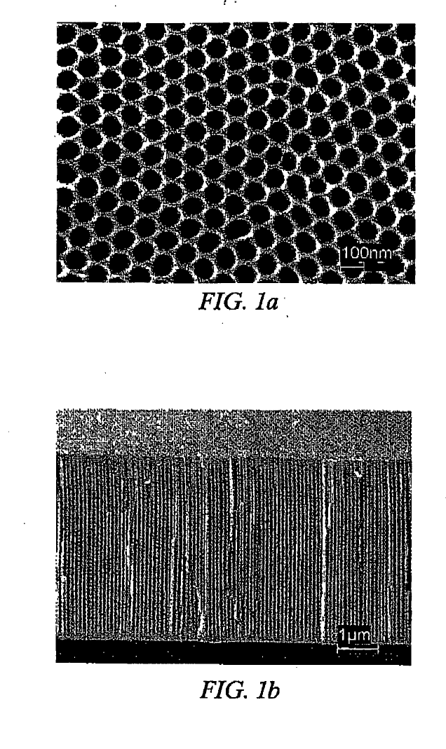

Initially, with reference to FIGS. 1a-b, according to known techniques, an anodic alumina membrane is typically fabricated by an electrochemical process where an aluminum substrate is connected as anode and an inert material, like platinum, gold or even lead, is connected as cathode. An electrolyte, e.g., phosphoric acid, sulphuric acid, oxalic acid or chromic acid can be used. By applying a constant voltage of ˜25-200 V the aluminium oxidizes and a porous oxide is formed. The pore size of the oxide is dependent upon the anodisation voltage and the oxide thickness is dependent on the anodisation time, pH of the electrolyte, and temperature. After anodisation, the remaining aluminum substrate can be dissolved, e.g., by using a saturated mercury chloride solution. The remaining anodic alumina membrane can be further treated in e.g. phosphoric acid in order to widen the pores.

For a satisfactory sensor material for SERS analysis it is desired to have a metal, e.g., silver, gold, copper, palladium, etc., surface, which is textured in the nano-dimension. In order to strongly enhance the Raman signal it is also important that the surface is large. By depositing nanoparticles, which densely cover the pore walls of a porous material, like anodic alumina, which have a large microscopic surface, a very large metal nanoparticle surface is obtained. In order to optimize the yield in the SERS analysis it is necessary to choose a light source of proper wavelength, which in turn is dependent on the nano particles size. The analytical yield is also dependent on the adsorption of the substance to be analyzed, such that the surface, e.g., the metal nanoparticles, may be optimized with respect to size, geometry and composition. Another factor for SERS analysis is having a non-contaminated surface; therefore, it may be desirable that the analyzing surface can be heated to high temperatures (˜500° C.) in order to remove contaminants. However, an alternative would be an analyzing surface that is cheap enough to be discarded after use. The anodic alumina membrane additionally withstands heating to temperatures above 800° C., thereby enabling removal of contaminants.

The anodic alumina membrane described above is a nano porous material with pore sizes which can be tailored from about 5 nm to about 400 nm. The pore length can be as long as about 100 μm. An advantage of providing a nano structured surface inside the pores of a nano porous material such as the above described anodic alumina membrane, is that, instead of receiving information from a surface layer, information from a 3-D volume will be detected. As a result, the sensitivity may increase drastically, e.g., instead of receiving information from a nanostructured surface layer, information from thousands of equivalent layers will be achieved, increasing the sensitivity considerably.

Another advantage of the membrane structure is that the gas (air) to be analyzed can be introduced as a flow through the sensor structure making use of the enormous surface area and reducing the measuring time. Another advantage using nano porous alumina is the inert character of the material. Nano porous alumina can be heated to high temperatures (1000° C.) and be introduced to a corrosive surrounding without deteriorating.

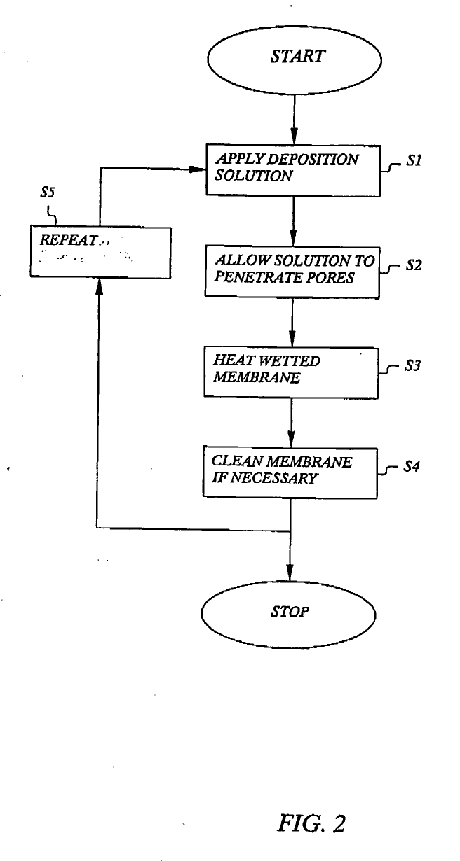

According to an embodiment, an example of which is shown in FIG. 2, the invention comprises a sequential method of manufacturing a permeable sensor structure comprising a porous anodic alumina membrane with deposited nanoparticles on the pore walls.

An anodic alumina membrane may be manufactured with deposited palladium nanoparticles on the pore walls. Palladium ions rapidly reduce to metallic palladium at room temperature. However, it has previously been considered extremely unlikely for other ions of other elements, such as gold and silver to easily reduce at room temperature. Surprisingly enough, the inventors have discovered that it is possible to deposit silver and also other elements with a similar method, in accordance with the present invention.

Initially, according to the embodiment of the present invention shown in FIG. 2, a small amount, e.g., a drop, of a deposition solution is applied at step S1 to an upper surface of the membrane. Subsequently, the deposition solution is distributed at step S2 into the pores by means of capillary forces, in order to completely wet the pore walls. The membrane (and the solution) is heated at step S3 to a temperature sufficient to evaporate the solvent. The temperature is determined by the solvent that is used. Consequently, the solute in the deposition solution is deposited as a film on the pore walls. Almost at once the ions forming the film are reduced to form separated nanoparticles on the pore walls. If desired, the resulting structure is cleaned at step S4 with some suitable solution or distilled water.

In order to control the size and the distribution of the nanoparticles, the deposition steps may be repeated at step S5 until a desired size and distribution of the nano particles is achieved. The size and distribution of the nano particles can also be controlled by varying the concentration of the deposition solution, either between the respective deposition cycles or set of deposition cycles.

According to an embodiment, the deposition solution is a silver-containing solution, e.g., silver nitrate (AgNO₃), to provide silver nano particles. The concentration of the solution can be varied within the range 1×10⁻⁶ to 15 M, or advantageously within the range 1×10⁻⁶ to 0.5 M, depending on the desired geometry and distribution of the particles.

According to another embodiment, the deposition solution can be varied between the deposition cycles to provide a multilayered structure. For instance, in order to enable depositing gold nanoparticles on the pore walls of anodic alumina using the method according to the invention, one may initially deposit silver or palladium nanoparticles on which gold from a gold containing deposition solution can nucleate. Palladium can be deposited by utilizing a deposition solution containing a palladium hexaamin, Pd(NH₃)₆²⁺ complex. In that case the resulting nanoparticles will comprise an inner silver or palladium core surrounded by at least one atomic layer of gold. A suitable gold containing solution is Auric acid, or HAuCl₄, with a concentration in the range 1×10⁻⁶ to 5 M.

Multilayer particles comprising a plurality of elements can be fabricated by exposing the anodic alumina membrane to a plurality of different deposition solutions during the deposition cycles.

By first depositing silver nanoparticles and later depositing gold on top of the already existing silver nanoparticles, core- and shell nanoparticles can be produced. Silver can be deposited again and form a third layer. This may be repeated any number of times and other metal salts or compounds may be used as deposition solution, e.g., salt of platinum, copper, nickel, cobalt, rhodium, iridium, and palladium.

Yet another embodiment of the present invention comprises annealing the deposited multilayer nanoparticles after the deposition cycles are performed. This enables alloyed nanoparticles to be deposited on the pore walls of the anodic alumina membrane.

The above described annealing procedure, comprising varying annealing time and varying annealing temperature, can be used to control particle size, particle composition and particle homogeneity. The annealing may take place in between the deposition cycles or after the final deposition cycle.

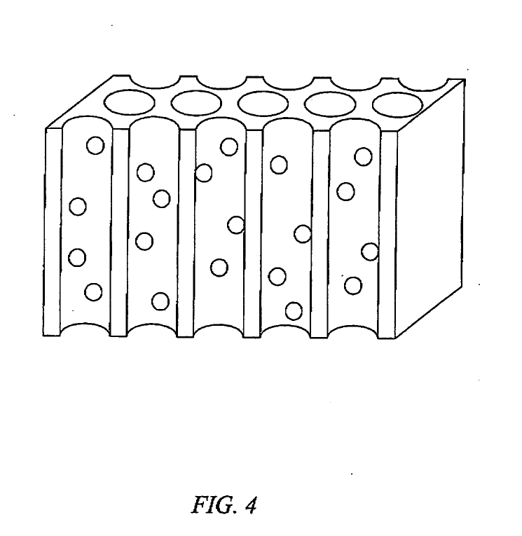

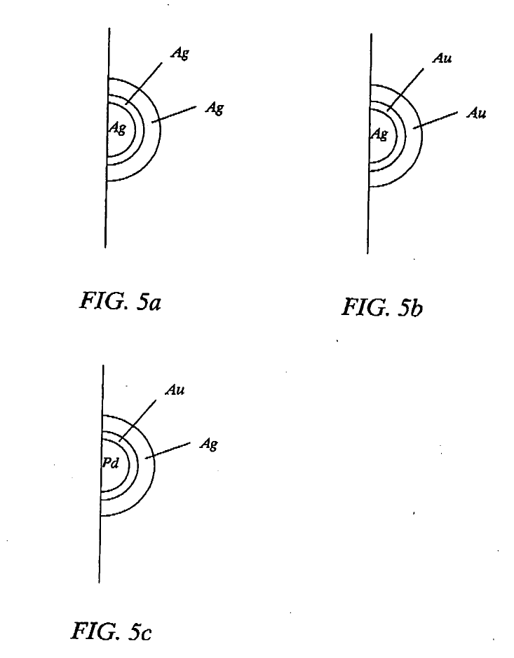

Various embodiments of sensor materials according to the invention, comprising anodic alumina membranes with nanoparticles in the pores, are described below with reference to FIGS. 4-5.

FIG. 4 shows a schematic exploded view of an embodiment of an anodic alumina membrane with deposited nano particles, according to the present invention. The structure comprises a permeable porous anodic alumina membrane with sequentially deposited silver or gold nanoparticles on the pore walls, as is further described hereinbelow. The structure may be manufactured in such a manner that the size and distribution of the nanoparticles can be controlled and tailored for specific applications. The structure can comprise, e.g., silver and/or gold nanoparticles, with a homogeneous or non-homogeneous internal structure.

An embodiment of a sensor material according to the present invention is shown in FIG. 5a, the structure comprising a porous anodic alumina membrane with deposited silver particles on the pore walls. The silver nanoparticles of the embodiment are sequentially deposited, which is indicated by the layered structure. In this case, the nano particles have been deposited with three deposition cycles, which is shown by the three silver layers. Although the layers are shown as being distinguishable as separate layers in FIG. 5a, the layers may instead be indistinguishable when the same deposition solution has been used.

Another embodiment of a material according to the present invention, is shown in FIG. 5b, the structure comprising a porous anodic alumina membrane with deposited gold nano particles on the pore walls. As described earlier, gold may not nucleate well on the membrane; instead, an initial core particle of, e.g., silver, may be deposited to provide nucleation sites for the gold atoms. In the example, the deposited gold particles comprise an inner silver core surrounded by two layers of gold.

Yet another embodiment of a material according to the present invention, is illustrated by FIG. 5c. The material comprises a porous anodic alumina membrane with deposited multi-layered nanoparticles comprising an inner core of palladium surrounded by a layer of silver, which in turn is surrounded by an outer layer of silver. However, the inner core could comprise silver instead.

It is understood that the number of layers and the constituents of each layer can be varied without departing from the present invention.

Although the embodiments above describe deposition of nano particles by providing a liquid deposition solution, it is also possible to use techniques for deposition using gaseous reactants. In that case, a difference may be to replace applying the deposition solution at step S1 with a step of introducing a flow of gaseous reactants through the pores of the alumina membrane. Allowing, at step S2, capillary forces to distribute the deposition solution in the pores may be replaced with allowing enough time for the gaseous reactants to permeate the pores of the membrane. The steps may be repeated until the predetermined particle size and particle density on the pore walls is achieved, according to the present invention. These gas phase based techniques include:

Chemical vapor deposition, CVD: CVD is a technique where gaseous reactants are introduced into a reactor. On or in the vicinity of a substrate surface a CVD reaction, yielding a solid reaction product, occurs. Gaseous reaction products are also formed and leave the reactor. The CVD technique is a very versatile deposition technique enabling a very careful control of deposition rate, chemical and phase composition as well as microstructure. A characteristic feature of the technique is also that all surfaces exposed to the vapor will be deposited. Thus, films of uniform thickness and microstructure can be produced on substrates having complicated shapes. Another feature is that CVD can be used for so called area-selective deposition, e.g., on substrates, exposing different phases to the vapor; the deposit can be localized to the desired phase without depositing on the other phase(s). Since the localization is based on chemical recognition there are practically no limitations in the lateral dimensions of the deposit. Area-selective deposition is employed particularly in the microelectronics and optical communication industries.

Atomic Layer Epitaxy, ALE: In CVD the precursors are mixed and introduced continuously in the reactor. In ALE, however, the precursors are not mixed and are introduced into the reactor pulse by pulse. This means that the chemical reactions occur sequentially and that they are decoupled to a large extent. In the first gas pulse, a monolayer of molecules are adsorbed onto the substrate surface. After a rinsing pulse with non-reactive gas, another gas is introduced in a second pulse and reacts with the previously adsorbed monolayer to form another monolayer or to take away undesired elements from the initially adsorbed monolayer. With this gas pulse technique, based on the monolayer adsorption, materials structures can be built up in a very controlled way monolayer by monolayer. By counting the number of gas pulses, the film thickness can be controlled within a monolayer. A characteristic feature of ALE (as well as CVD) is that it allows for deposition on all surfaces exposed to the reaction gas, which means that films of uniform thicknesses and properties can be grown on substrates with complicated shapes. For example, superlattices, multilayers, films with artificial microstructures, films on clusters and particles may be produced by this technique. Moreover, by using chemical recognitions, ALE can also be run in an area-selective mode.

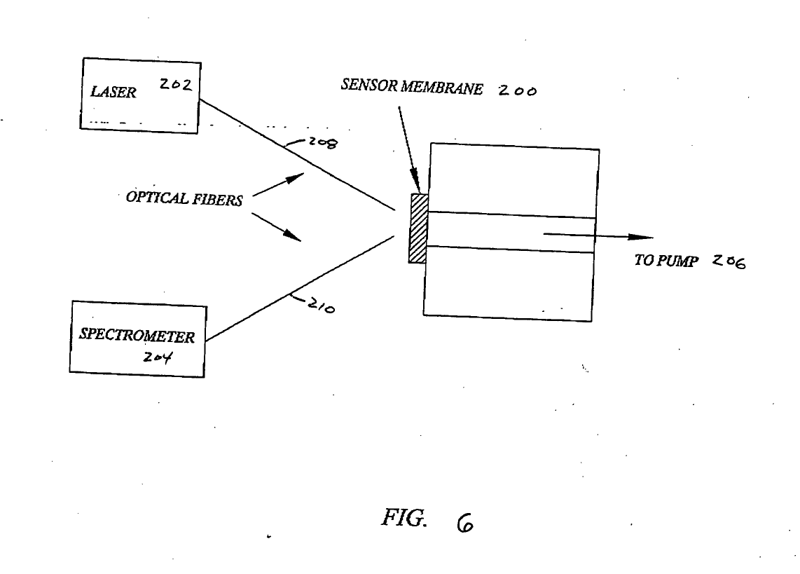

With reference to FIG. 6, the present invention may comprise using the above described structure as a SERS analysis surface, where the gas or liquid that needs to be analyzed is allowed to permeate and flow through the porous membrane. An incident laser beam undergoes Raman scattering on molecules bound to or in close proximity of the deposited silver nano particles. Subsequently, the scattered laser beam is analyzed and a Raman spectrum is collected.

FIG. 6 illustrates an embodiment of the present invention in which there is provided an arrangement for the use of the sensor structure. The schematic arrangement comprises a sensor membrane 200, a laser 202, a spectrometer 204 and a pump 206 for directing a flow of gas or liquid through the permeable membrane. The laser also comprises at least an optical fiber 208 for directing a beam from the laser 202 to the membrane. Also, the spectrometer 204 comprises an optical fiber 210 for directing the scattered laser beam from the membrane. It should be understood that other components providing the same functionality can also be used.

In order to enable an optimal detection, the wavelength of the incident laser beam and the size and distribution of the silver or gold particles may be closely tuned to each other.

Silver nanoparticles, as well as homogenous films, may be deposited along the pore walls of an anodic alumina membrane, e.g., using a metal-organic silver precursor, Ag(I)(COD)hfac, with the ALE technique.

The present invention may generally comprise a permeable porous anodic alumina membrane, which has been subjected to, e.g., silver, gold, copper or palladium, nanoparticle deposition on the pore walls. The deposition is made by a sequential deposition technique using salt solutions of the metals and quick heating. The dimensions as well as the composition of the formed particles inside the membrane pores can be tailored by variation of the deposition parameters. One possible application for the invention comprises the use of the membrane with deposited nanoparticles as a sensor material for detection of very low concentrations of gases and dissolute substances using e.g. surface enhanced Raman spectroscopy (SERS). However, other possible fields of applications for the sensor structure of the invention may include, without being limited to, catalysis, magnetic structures, and photonic wave guides.

Many studies have been done to date for the purpose of creating a good SERS surface. Most of the studies are based on lithographically patterned gold or silver surfaces, which give good control of the surface topography, but lack the highly enlarged surface, which is required for analyzing very low concentrations.

According to various examples of the present invention, silver particles are deposited on the pore walls of the anodic alumina membrane using a silver nitrate solution (concentration between 1×10⁻⁶ and 15 M) which is applied to the membrane as a droplet. The membrane may get completely soaked by the AgNO₃ solution, whereafter the membrane is heated to a temperature between 300 and 800° C. The membrane can be heated using a heated air flow, or an oven. The sample is then carefully washed with de-ionized water to remove reaction products. The deposition procedure can be repeated several times in order to tailor the size and size distribution of the formed nanoparticles, since the particles increase in size with every deposition cycle.

The particle size can be effected by various factors, such as, controlling the silver nitrate concentration in the deposition solution or varying the number of deposition cycles.

The reduction temperature may affect the density of the particles deposited, that is, the number of particles per area unit. Typically, higher deposition temperatures may result in higher particle density on the pore walls.

Depending on the area of application, the structure of the anodic alumina membrane and the nanoparticles can be varied in many ways, including but not limited to, the following ways:
1. The membrane thickness can be varied between about 0.5-100 μm;
2. The inter pore distances can be varied between about 20-500 nm;
3. The pore diameters can be varied between about 5-400 nm;
4. The silver nanoparticles on the pore walls of the anodic alumina membrane can have diameters ranging between about 0.5 nm-50 nm;
5. The coverage of the silver nanoparticles on the pore walls of the anodic alumina membrane can be varied between direct contacts between particles to about 1 particle per μm²;
6. The gold nanoparticles on the pore walls of the anodic alumina membrane can have diameters ranging between about 0.5 nm-50 nm;
7. The coverage of the gold nanoparticles on the pore walls of the anodic alumina membrane can be varied between direct contacts between particles to about 1 particle per μm²;
8. The multilayer nanoparticles on the pore walls of the anodic alumina membrane can have diameters ranging between about 0.5 nm-50 nm;
9. The coverage of the multilayer nanoparticles on the pore walls of the anodic alumina membrane can be varied between direct contacts between particles to about 1 particle per μm²;
10. The alloy nanoparticles on the pore walls of the anodic alumina membrane can have diameters ranging between about 0.5 nm-50 nm; and
11. The coverage of the alloy nanoparticles on the pore walls of the anodic alumina membrane can be varied between direct contacts between particles to about 1 particle per μm².

The present invention provides a synthesis route to directly grow nanoparticles on the pore walls of nano porous anodic alumina membranes. By applying the proper deposition conditions the particle size as well as the particle density (number of particles per area unit) and particle composition can be tailored.

An advantage of the above-described methods of manufacture, and of the structures obtained thereby, according to various embodiments of the present invention, may include the provision of a sensor structure with a large analysis surface area, with increased sensitivity to ultra low concentrations of molecules in gases or liquids, and with nanostructures with controlled size and distribution.

Yet another advantage of the present nano porous alumina membrane sensor is the low cost for fabrication. This makes it possible to dispose the membrane instead of cleaning it. Thereby, the use membrane can be replaced in a cost efficient manner. Still further advantages of the present invention may include the provision of a sensor for cost-efficient detection of explosive compounds, which may be discarded after use, while enabling the highly sensitive detection of explosive compounds by surface enhanced Raman spectroscopy.

The anodic alumina membrane typically has a thickness between 0.5 to 100 μm, an inter pore distance between 20 to 500 nm and a pore diameter between 5 to 400 nm. The porous structure enables providing a sensor with a small two dimensional surface but a large three dimensional analysis surface i.e. an analysis volume. This means that instead of receiving information from a surface layer, information from a volume will be detected. This means that the sensitivity will increase drastically, i.e. instead of receiving information from a nanostructured surface layer, information from thousands of equivalent layer will be achieved, increasing the sensitivity considerably.

A material according to the invention may, according to various embodiments, be utilized in sensors, e.g., for detection of substances by surface enhanced Raman spectroscopy such as for the detection of a plurality of substances indicating the presence of explosives. For example, recent interest for detectors of low concentrations of certain compounds in a variety of areas has increased. One such area is the detection of a plurality of explosive compounds in public areas such as, e.g., airports, bus terminals, and train stations. Other areas include mail services, public transportation services and so on. In order to provide reliable service, the detectors need to be able to detect low to ultra low concentrations of a variety of explosive compounds and at the same time be small and inexpensive enough to enable large numbers of detectors and implementation in e.g. mail cars, trains, luggage carts, etc.

However, other substances can also be detected, e.g., toxic substances or other. The material may be utilized as a catalytic surface. Other areas of application include, but are not limited to, fuel cells and accumulators, e.g., batteries and biotechnology.

It will be understood by those skilled in the art that various modifications and changes may be made to the present invention without departure from the scope thereof, which is defined by the appended claims.

What is claimed is:

1. A method of manufacturing a permeable sensor structure, comprising the steps of:
applying a deposition solution, that includes nanoparticles in a solvent, on a surface of a permeable anodic alumina membrane, the membrane including a plurality of pores each of which being defined by walls;
allowing capillary forces to distribute the deposition solution in the pores of the membrane; and
heating the membrane to evaporate the solvent and deposit the nanoparticles on the walls of each of the pores.

2. The method according to claim 1, further comprising the step of cleaning said membrane after the heating step.

3. The method according to claim 1, wherein the steps form a deposition cycle, and wherein the steps are repeated so as to control at least one of a size and a distribution of the deposited nanoparticles.

4. The method according to claim 1, wherein said nanoparticles comprise silver.

5. The method according to claim 4, wherein said deposition solution is a silver nitrate solution wherein said silver nitrate solution has a concentration in the range of 1×10⁻⁶ to 15 M.

6. The method according to claim 5, wherein said silver nitrate solution has a concentration in the range of 1×10⁻⁶ to 0.5 M.

7. The method according to claim 3, wherein, in at least one of the repeated set of steps, a different deposition solution is applied so as to provide nanoparticles with a layered internal structure.

8. The method according to claim 3, further comprising the step of annealing the material after a deposition cycle to provide alloyed nanoparticles.

9. The method according to claim 8, wherein the step of annealing the material is performed between deposition cycles to provide layered annealed nanoparticles.

10. The method according to claim 8, wherein said annealed nanoparticles comprise a concentration gradient from the center to the particle surface or concentration gradients between the internal layers.

11. The method according to claim 1, wherein the heating step includes heating to a predetermined temperature in the range 300° C. to 800° C.

12. The method according to claim 1, wherein the heating step includes heating for a predetermined time in the range 5 seconds to 48 hours.

13. The method according to claim 1, wherein a gold-containing deposition solution is used to deposit gold.

14. The method according to claim 13, wherein said gold-containing deposition solution comprises Auric acid.

15. The method according to claim 14, wherein said Auric acid has a concentration in the range 1×10⁻⁶ to 15 M.

16. The method according to claim 7, wherein said different deposition solution comprises one of silver, copper, gold, platinum, rhodium and iridium.

17. A sensor structure comprising a permeable porous anodic alumina membrane with sequentially deposited nanoparticles on pore walls of the membrane.

18. The sensor structure according to claim 17, wherein said nanoparticles comprise at least one of silver, gold, copper, platinum, rhodium and iridium.

19. The sensor structure according to claim 17, wherein said nanoparticles comprise palladium.

20. The sensor structure according to claim 17, wherein said nanoparticles comprise a multilayered structure.

21. The sensor structure according to claim 20, wherein each said nanoparticle comprises an inner nanoparticle of silver surrounded by at least an outer layer of another metal.

22. The sensor structure according to claim 20, wherein said nanoparticles each comprise at least an inner nanoparticle of palladium surrounded by at least an outer layer of another metal.

23. The sensor structure according to claim 20, wherein said nanoparticles comprise at least one layer of at least one of platinum, copper, nickel, cobalt, rhodium, iridium or palladium.

24. The sensor structure according to claim 20, wherein said nanoparticles comprise annealed particles.

25. The sensor structure according to claim 24, wherein the annealed particles comprising a concentration gradient from the core to the surface of the outer layer.

26. The sensor structure according to claim 24, wherein said annealed particles comprise a layered structure with concentration gradients within at least one layer.

27. The sensor structure according to claim 17, wherein the sensor structure is suitable to be used as a detector for detecting explosive compounds.

28. The sensor structure according to claim 24, wherein the sensor structure is suitable to be used for surface enhanced Raman spectroscopy.

29. A method comprising the steps of:
providing a permeable porous anodic alumina membrane with sequentially deposited nanoparticles on pore walls of the membrane; and
using the membrane as a sensor for Surface Enhanced Raman Spectroscopy.

30. The method according to claim 29, wherein the sequentially deposited nanoparticles are of silver or gold.

31. The method according to claim 29, wherein the method further comprises detecting a plurality of substances in a gas or liquid.

32. The method according to claim 31, wherein said plurality of substances comprises molecules indicative of the presence of explosive compounds.

33. The method according to claim 32, further comprising the step of directing said gas or liquid through the pores of said membrane to be analyzed.

34. The method according to claim 33, further comprising the steps of:
illuminating the pores of said membrane with a laser beam with a predetermined wavelength;
scattering said laser beam against molecules of said gas or liquid attached to or close to said silver or gold nanoparticles;
detecting the scattered laser beam; and
analyzing the Raman spectra to detect molecules attached to or close to the silver or gold particles.
